(19) United States
(12) Patent Application Publication
(10) Pub. No.: US 2004/0194604 A1
(43) Pub. Date: Oct. 7, 2004

(54) Knife holder for a cutting knife of a microtome

(76) Inventor: Siegfried Fischer, Nibelungenring (DE)

Correspondence Address: HODGSON RUSS LLP, ONE M & T PLAZA, SUITE 2000, BUFFALO, NY, 14203-2391, US

(21) Appl. No.: 10/811,601

(22) Filed: Mar. 29, 2004

(30) Foreign Application Priority Data
Apr. 3, 2003 (DE) 203 05 494.6

(51) Int. Cl. B26D 1/00

(52) U.S. Cl. 83/651; 83/915.5

(57) ABSTRACT

A knife holder 1 for a cutting knife 2 of a microtome for cutting samples is described. Knife holder 1 has a pressure plate 3 for locking the cutting knife in the knife holder and for discharging the cut sample. A U-shaped frame 4, open toward edge 5 of cutting knife 2, is associated with pressure plate 3.

### CROSS REFERENCE TO RELATED APPLICATIONS

This application claims priority of the German utility model application 203 05 494.6 filed Apr. 3, 2003 which is incorporated by reference herein.

### FIELD OF THE INVENTION

The invention concerns a knife holder for a cutting knife of a microtome.

### BACKGROUND OF THE INVENTION

Knife holders that receive and securely clamp cutting knives are used in microtomes. Two types of cutting knives are used in microtomes: a blade-shaped knife, configured similarly to a razor blade, for one-time use; and a stable, wedge-shaped steel knife that can be resharpened.

Different knife holders are used in microtomes depending on the type of knife. A knife holder having a pressure plate for clamping a blade-shaped cutting knife is known from DE 44 35 072 C1 (corresponding to U.S. Pat. No. 5,964,138). A knife holder having a pressure plate for a stable, wedge-shaped steel knife is depicted and described in DE 195 06 837 C1 (corresponding to U.S. Pat. No. 5,669,278).

With both knife holders, the various cutting knives can be held securely in the microtome and samples can be precisely cut. After cutting, the very thin samples have the disadvantageous property of rolling up. Rolled-up samples are very difficult to apply onto a specimen slide for subsequent examination with a microscope. In addition, there is a risk that the samples may break.

Section stretching devices are used to prevent undesirable rolling. These section stretchers have a glass or plexiglas plate that is arranged on the knife back, parallel to and at a short distance from the knife edge, in such a way that a thin gap is created between the knife back and the plate. During cutting, the cut sample slides into the gap between the plate and the knife back. A section stretcher of this kind is known from DE 100 48 724 (corresponding to U.S. Pat. No. 6,705,187).

If the samples are very thin, they may adhere to the glass plate and can be detached only with great difficulty and incompletely. These samples are then unusable for microscopic examination.

In ultramicrotomy, in which extremely small and thin samples (as thin as 1 nm) are cut for electron microscopy, water-filled “boats” are arranged directly on the diamond or glass knife to receive the section. Here, during cutting, the section slides directly from the triangular diamond or glass knife onto the water surface and is removed from there. Apparatuses of this kind are depicted and described in U.S. Pat. No. 5,551,326 and JP 09021733 A.

These “boats” cannot be used on metal microtome knives, however, since the metal knives are clamped into knife holders by way of a pressure plate.

### SUMMARY OF THE INVENTION

It is therefore the object of the present invention to develop the known knife holders for metal knives so as also to enable section removal from a water surface.

This object is achieved, according to the present invention, by providing a knife holder for metal microtome knives with a U-shaped frame.

The invention is notable for the fact that the U-shaped frame is mounted on the pressure plate of the knife holder, and the frame's open side is directed toward the knife edge. A water pan is thus formed together with the pressure plate, so that the cut samples can slide from the knife edge directly onto the water surface.

In a development of the invention, the frame is mounted detachably on the pressure plate. Screws and other mounting means can be provided for this purpose.

In a further embodiment of the invention, the frame is embodied in one piece. The frame can, of course, also be shaped directly onto the pressure plate and thus form a one-piece water pan.

In a further embodiment, the means for mounting the frame on the pressure plate are embodied magnetically, so that the frame can easily be detached from the pressure plate in order to clean and disinfect the knife holder.

Provision is also made for arranging a seal between the frame and the pressure plate.

In a development of the invention, the frame or the water pan has a pivotably supported bail that, if necessary, can be pivoted in front of the knife edge as a cut protector.

In a further embodiment of the invention, the two limbs of the U-shaped frame, arranged parallel to one another, are of wedge-shaped configuration so that when the knife is placed obliquely, the water surface and the upper rim of the frame form planes arranged at least approximately parallel to one another. This is advantageous in particular when removing the section or several sections from the water surface using a specimen slide.

A further consequence of the simple configuration is that the knife holder is still easy to clean and disinfect.

### BRIEF DESCRIPTION OF THE DRAWINGS

The invention will be explained in more detail on the basis of an exemplary embodiment, using the schematic drawings in which:

FIG. 1 is a first view of the knife holder; and

FIG. 2 is a second view of the knife holder.

### DETAILED DESCRIPTION OF THE INVENTION

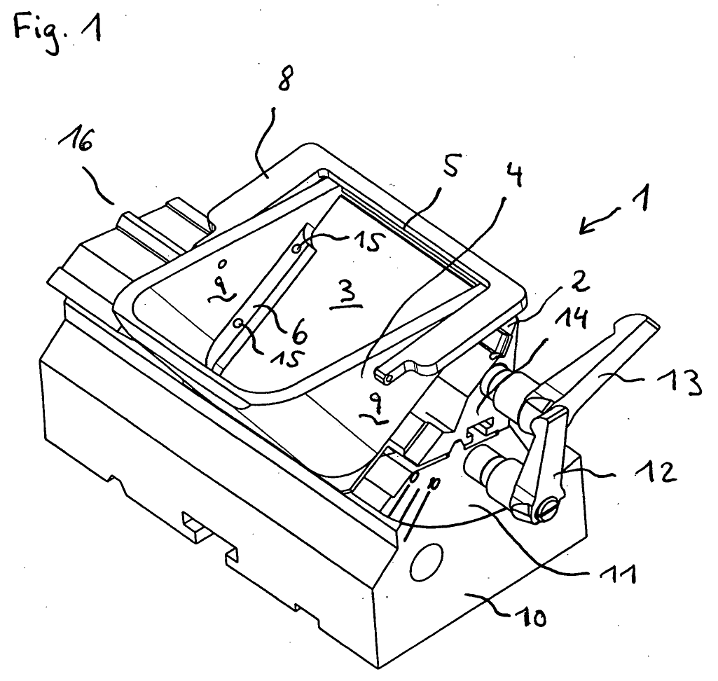

FIG. 1 is a first view of knife holder 1 with a base 10 and a pivoting part 11 arranged pivotably thereon, the pivoting motion being locked by way of immobilizer 12. Pivoting part 11 carries: a knife receptacle 14 for a cutting knife 2 having a knife edge 5; a pressure plate 3 for clamping cutting knife 2; and a U-shaped frame 4 arranged on the pressure plate. Pressure plate 3 is embodied movably in order to clamp cutting knife 2 by way of a clamping lever 13.

Knife receptacle 14 is arranged displaceably along a guide 16 on pivoting part 11.

Frame 4 is equipped with two limbs 9 arranged parallel to one another, and is mounted on pressure plate 3, with its open side toward knife edge 5, via a magnet 6. As an alternative to magnetic mounting, frame 4 can also be mounted on pressure plate 3 with screws 15.

U-shaped frame 4 forms, together with pressure plate 3, a pan that is preferably filled with water. The result of this is that a cut sample is conveyed from knife edge 5 directly onto the water surface, and can be removed therefrom using a conventional specimen slide.

Limbs 9 of frame 4 are wedge-shaped. This has the advantage that when knife 2 is placed obliquely, the frame rims and the water surface lie almost in one plane, thus simplifying removal of the section from the water surface. The size of the pan also means that multiple sections or so-called section strips can be removed from the water surface.

To prevent injuries, a pivotably supported bail 8 is arranged on the two limbs 9 of the frame and can be pivoted in front of knife edge 5 when knife holder 1 is not in use.

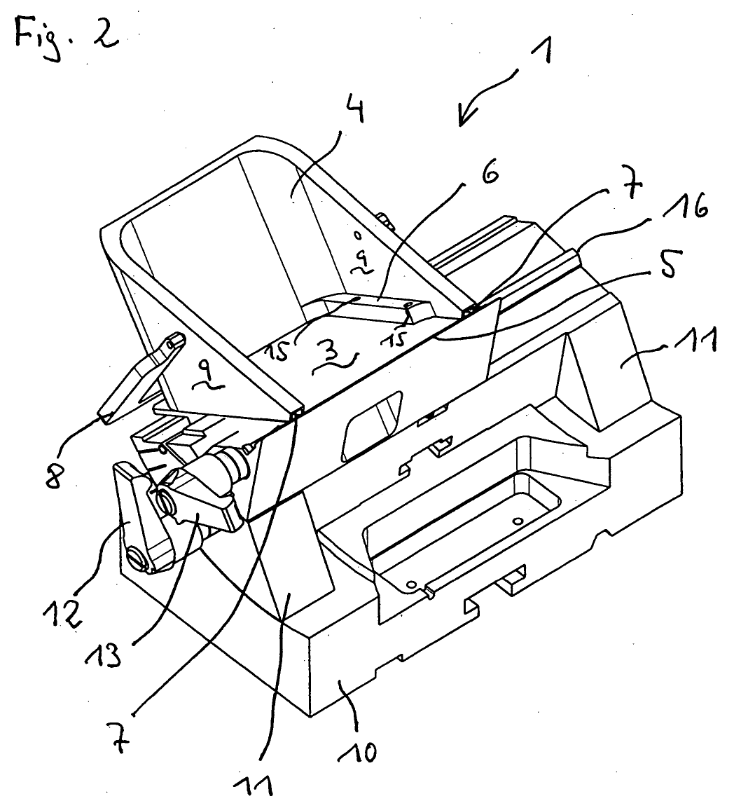

FIG. 2 is a second view of knife holder 1 in the working position. Here bail 8 is located not in front of knife edge 5 but rather in the pivoted-back position.

Provided between frame 4 and pressure plate 3 is a seal 7, arranged peripherally on frame 4, that prevents leakage from the water-filled pan.

Parts List

1 Knife holder

2 Cutting knife

3 Pressure plate

4 Frame

5 Knife edge

6 Magnet

7 Seal

8 Bail

9 Limb of 4

10 Base

11 Pivoting part

12 Immobilizer

13 Clamping lever

14 Knife receptacle

15 Screws

16 Guide

What is claimed is:

1. A knife holder (1) for a cutting knife (2) of a microtome having a knife edge (5) for cutting samples, the knife holder comprising:
a pressure plate (3) for locking the cutting knife (2) in the knife holder (1) and for discharging the cut sample; and
a U-shaped frame (4) associated with the pressure plate (3) and open toward the knife edge (5) of the cutting knife (2).

2. The knife holder (1) as defined in claim 1, wherein the frame (4) and the pressure plate (3) cooperate to form a water pan.

3. The knife holder (1) as defined in claim 1, wherein the frame (4) is a one-piece component.

4. The knife holder (1) as defined in claim 1, wherein the frame (4) and the pressure plate (3) are combined in a one-piece component.

5. The knife holder (1) as defined in claim 1, wherein the frame (4) is mounted detachably on the pressure plate (3).

6. The knife holder (1) as defined in claim 5, further comprising magnets (6) for mounting the frame (4) on the pressure plate (3).

7. The knife holder (1) as defined in claim 1, further comprising a fluid seal (7) between the frame (4) and the pressure plate (3).

8. The knife holder (1) as defined in claim 1, further comprising a bail (8) pivotably mounted to the frame (4) for selectively covering the knife edge (5) to protect users from cuts.

9. The knife holder (1) as defined in claim 1, wherein the U-shaped frame includes two parallel limbs (9), and each of the two limbs (9) is wedge-shaped.
